(19) United States
(12) Patent Application Publication
(10) Pub. No.: US 2008/0148591 A1
(43) Pub. Date: Jun. 26, 2008

(54) MEASURING WHEEL

(76) Inventor: Chiu-Mei Kao Lin, Taoyuan (TW)

Correspondence Address: RABIN & Berdo, PC, 1101 14TH STREET, NW, SUITE 500, WASHINGTON, DC, 20005, US

(21) Appl. No.: 11/945,313

(22) Filed: Nov. 27, 2007

(30) Foreign Application Priority Data
Dec. 20, 2006 (TW) 095222447

(51) Int. Cl. G01B 3/12

(52) U.S. Cl. 33/772

(57) ABSTRACT

A measuring wheel includes a hollow handle respectively having a grip handle and a fork pivoted with a wheel at an upper and a lower end thereof. A counter is mounted on the grip handle or the handle, and inside of the handle has a link rod having a shock absorber. Both ends of the link rod are connected with the wheel and the counter respectively, whereby the rolling distance of the wheel is shown on the counter.

### BACKGROUND OF THE INVENTION

1. Field of the Invention

The present invention is generally related to an improved measuring wheel for measuring the lengths of arbitrary lines.

2. The Prior Arts

Referring to FIG. 1, a conventional measuring wheel 1 comprises a wheel 3, a handle 4, a grip handle, and a counter 2. The rotary motion of the wheel 3 is transmitted to the counter 2 by a transmission mechanism to measure the rolling distance of the wheel.

The conventional measuring wheel falls into two categories: the foldable and the unfoldable. The unfoldable measuring wheel includes a longer handle having a grip handle and a wheel formed at the upper and lower ends thereof respectively, and the counter is disposed on the handle. The transmission mechanism connects the counter with the wheel, whereby the rolling of the wheel is transmitted to the counter. Because the vibration of the rolling wheel affects the precision of the counter, the counter is preferably as close as possible to the wheel. Therefore, the counter is usually disposed on the handle close to the wheel so that the user has to bend low or squat to read the measured value displayed on the counter. Besides, because it is unfoldable, it is inconvenient to carry or store the unfoldable measuring wheel.

The conventional foldable measuring wheel comprises two sections of the handle pivotally connected with each other, whereby it is easy to carry or store. An upper handle is provided with a grip handle, and a lower handle is provided with a transmission mechanism and the counter. The rolling of the wheel is transmitted to the counter via the shorter transmission mechanism. Therefore, the counter of the foldable measuring wheel is still disposed close to the wheel. Thus the user still cannot read the measured value easily, when he stands.

### SUMMARY OF THE INVENTION

A primary objective of the present invention is to provide an improved measuring wheel in which a counter is disposed at a higher position, whereby the user could read the measured distance without bending low or squatting. In addition, the measuring wheel according to the present invention could be folded into a compact size for carry and storage when not in use.

The solution of the present invention is to provide a measuring wheel with a tubular handle having a grip handle and a fork pivoted with the wheel at an upper and a lower ends thereof respectively. A counter is mounted on the grip handle or the handle. The inside of the handle comprises a link rod having a shock absorber. Both ends of the link rod are connected with the wheel and the counter respectively, whereby the rolling distance of the wheel is measured and displayed on the counter.

In addition, the handle according to the present invention may be divided into two sections pivotally connected to each other so that the measuring wheel could be folded into a compact size for easy carry and storage. The two-section handle comprises an upper handle having the grip handle at the upper end thereof and a lower handle formed with the wheel at the lower end thereof. The lower end of the upper handle is pivotally connected with the upper end of the lower handle. The link rod includes an upper link rod disposed inside the upper handle and a lower link rod disposed inside the lower handle. The upper end of the upper link rod connects with the counter, and the lower end of the upper link rod is formed with an upper link joint. The lower end of the lower link rod connects with the wheel and the upper end is formed with a lower link joint engaged with the upper link joint. When the upper handle and the lower handle rotate relatively to each other to a side-by-side state, the upper link joint disengages from the lower link joint. When the upper handle and the lower handle rotate relatively to a straight-line state, the upper link joint engages with the lower link joint.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a conventional measuring wheel;

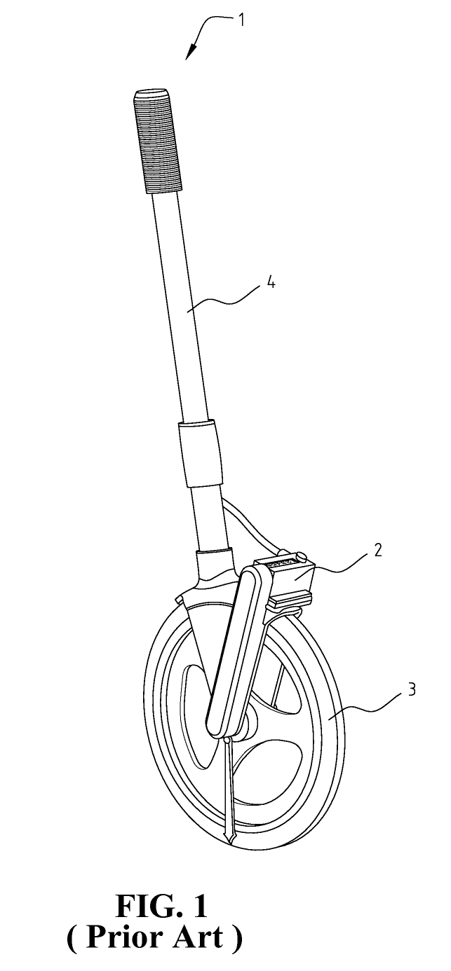

FIG. 2 is a perspective view showing a measuring wheel constructed in accordance with the present invention;

FIG. 3 is a schematic view showing the internal structure of the measuring wheel according to the present invention;

FIG. 4 is a perspective view showing the measuring wheel folded for carry; and

FIG. 5 is a perspective view showing the measuring wheel is folded and the kickstand is pulled down for storage.

### DETAILED DESCRIPTION OF THE PREFERRED EMBODIMENT

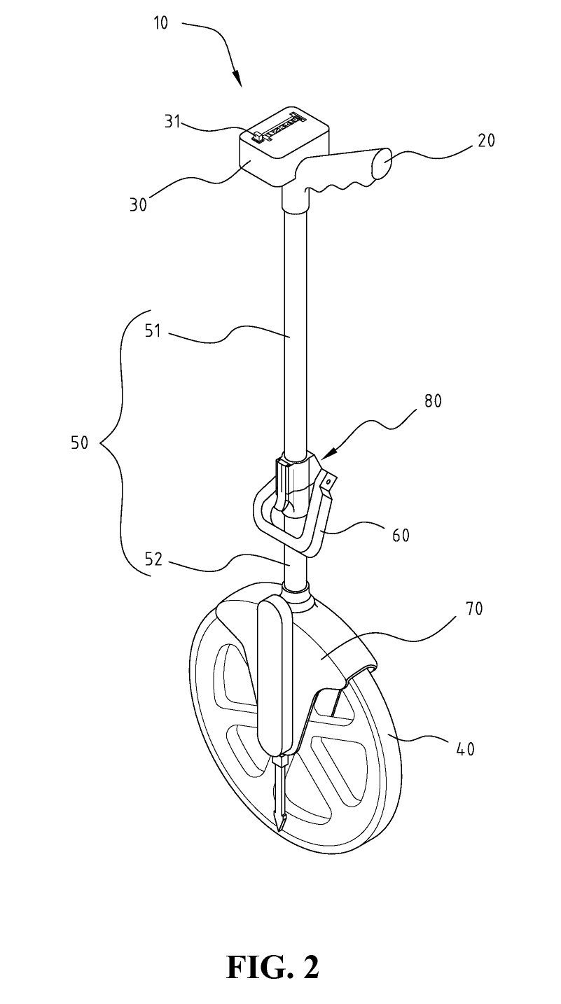

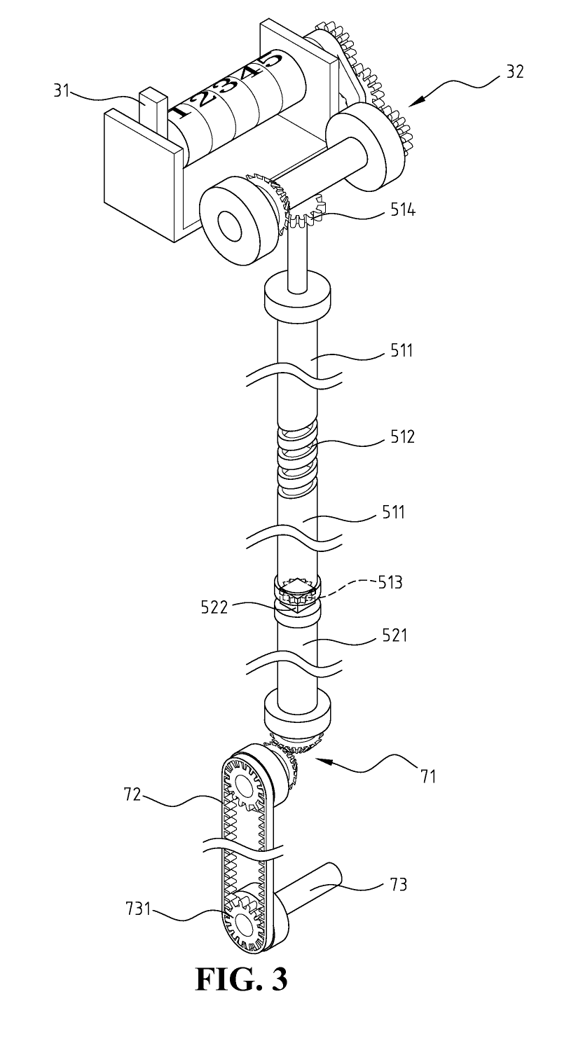

Referring to FIGS. 2 and 3, a measuring wheel 10 according to the present invention comprises a tubular handle 50 having a grip handle 20 disposed at an upper end thereof. A counter 30 is mounted on a front part of the grip handle 20, or an upper part of the handle 50. The counter 30 includes a reset button 31 that can reset the number shown on the counter by clicking the button. A lower part of the handle 50 connects with a fork 70 pivoted with a wheel 40. A transmission mechanism in the hollow portion of the handle 50 connects the wheel 40 with the counter 30 whereby the rolling distance of the wheel is measured and shown on the counter 30.

The measuring wheel 10 may be folded to a compact size for easy carry and storage. The foldable handle 50 according to the present invention comprises an upper handle 51 and a lower handle 52. A grip handle 20 is mounted at an upper end of the upper handle 51, and the fork 70 and the wheel 40 are disposed at a lower end of the lower handle 52. The lower end of the upper handle 51 is pivotally connected with the upper end of the lower handle 52. An upper link rod 511 is disposed inside the upper handle 51 and a lower link rod 521 is disposed inside the lower handle 52. An upper end of the upper link rod 511 is provided with a gear 514 to engage with a counter gear set 32 mounted within the counter 30, thereby connecting the counter 30 with the upper link rod 511. Part of a sidewall of the tubular upper link rod 511 is a shock absorber 512. The shock absorber 512 is a coil spring, thereby smoothing out a sudden shock impulse. Moreover, a lower end of the upper link rod 511 includes an upper link joint 513.

An upper end of the lower link rod 521 is provided with a lower link joint 522 to engage with the upper link joint 513, and a lower end of the lower link rod 521 is provided with a gear set 71. A timing belt 72 connects the gear set 71 with a gear 731 of a wheel axle 73. The upper link joint 513 and the lower link joint 522 respectively include a joint hole and a joint post corresponding to the joint hole. When the upper handle 51 and the lower handle 52 rotate relatively to each other to a side-by-side state, the upper link joint 513 disengages from the lower link joint 522. When the upper handle 51 and the lower handle 52 rotate relatively to each other to a straight-line state, the joint post is fitted into the joint hole, thereby engaging the upper link joint 513 with the lower link joint 522. Therefore, when the wheel 40 rotates, the rotary motion is transmitted to the counter 30 to show the distance value via the wheel axle 73, the gear set 71, the lower link rod 521, and the upper link rod 511. In addition, when the measuring wheel 10 works on an uneven surface and has an excessive up-and-down motion, the shock absorber 512 of the upper link rod 511 will smooth out the vibration that affect the measuring precision.

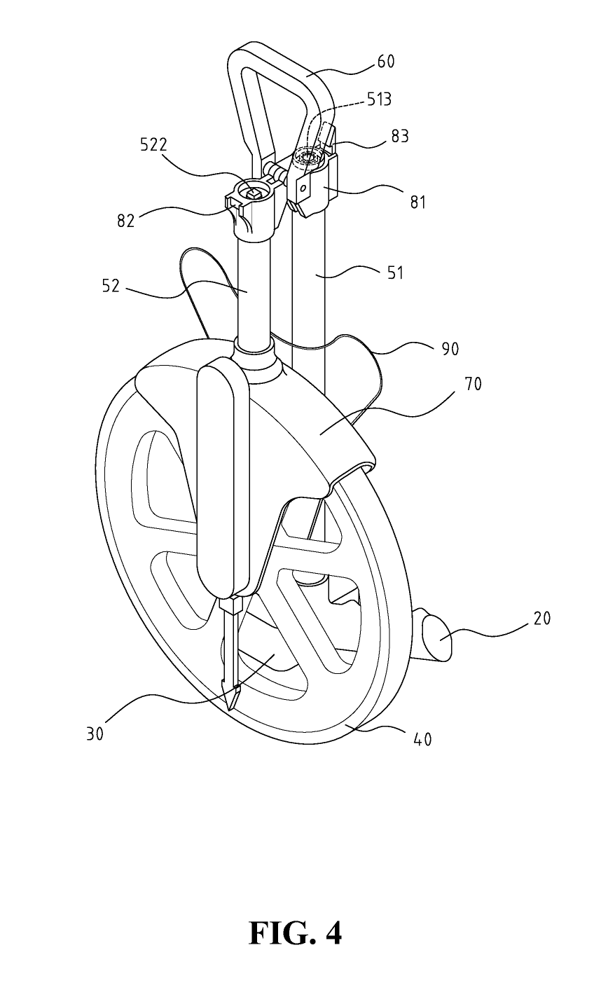

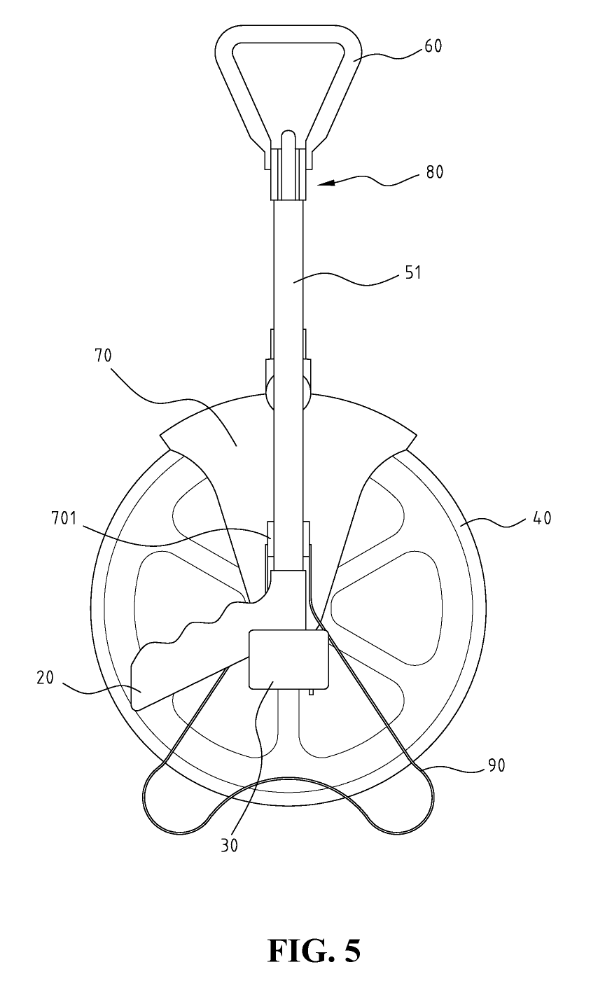

Referring to FIGS. 4 and 5, a joint where the upper handle 51 connects with the lower handle 52 comprises a fastening piece 80 to hold the upper and lower handles 51, 52 together. The fastening piece 80 comprises an upper fastener 81 at the lower end of the upper handle 51, and a lower fastener 82 at the upper end of the lower handle 52. A locking fastener 83 on the upper fastener 81 engages or disengages the upper fastener 81 and the lower fastener 82. When the locking fastener 83 is clicked open, the upper and the lower fasteners 81, 82 disengage from each other. When the measuring wheel is not in use, the locking fastener 83 is clicked open to disengage the upper fastener 81 from the lower fastener 82. The upper handle 51 and the lower handle 52 rotate relative to each other to the side-by-side state, and then the upper handle 51 is inserted into and secured in a U-shape slot fastener 701 of the fork 70. When the measuring wheel is in use, the upper handle 51 and the lower handle 52 rotate relative to each other to the straight-line state. The locking fastener 83 of the upper fastener 81 engages with the lower fastener 82, thereby connecting the upper handle 51 and the lower handle 52. The upper link joint 513 engages with the lower link joint 522, thereby connecting the upper link rod 511 with the lower link rod 521. Therefore, the transmission mechanism disposed inside the handle 50 transmits the rotary motion from the wheel 40 to the counter 30. In addition, one side of the fork 70 is provided with a kickstand 90. When the kickstand 90 is kicked out, three points given by the kickstand 90 and the wheel 40 support the measuring wheel 10 to stand. On the other way, when the measuring wheel is in use, the kickstand 90 is kicked back into place. Moreover, the fastening piece 80 is provided with a C-shape carry handle 60 whose both ends are pivotally connected therewith. Thus, after the measuring wheel is folded, the user could easily grasp the carry handle 60 without any trouble.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A measuring wheel comprising
a tubular handle having a grip handle and a fork at an upper end and a lower end thereof, respectively;
a wheel pivotally connected with the fork; and
a counter mounted on one of the grip handle and the handle;
wherein an inside of the handle is provided with a link rod having a shock absorber; wherein both ends of the link rod are connected with the wheel and the counter respectively, whereby a rolling distance of the wheel is measured and shown on the counter.

2. The measuring wheel as claimed in claim 1, wherein the shock absorber, which is a coil spring, is part of a sidewall of the tubular link rod.

3. The measuring wheel as claimed in claim 1, wherein the handle comprises an upper handle having the grip handle at an upper end thereof and a lower handle connected with the wheel at a lower end thereof; wherein a lower end of the upper handle is pivotally connected with an upper end of the lower handle; wherein the link rod includes an upper link rod inside the upper handle and a lower link rod inside the lower handle; wherein an upper end of the upper link rod is connected with the counter, and a lower end of the upper link rod includes an upper link joint; wherein a lower end of the lower link rod is connected with the wheel and the upper end of the lower link rod includes a lower link joint engaged with the upper link joint; wherein when the upper handle and the lower handle rotate relatively to each other to a side-by-side state, the upper link joint disengages from the lower link joint; wherein when the upper handle and the lower handle rotate relatively to each other to a straight-line state, the upper link joint engages with the lower link joint.

4. The measuring wheel as claimed in claim 2, wherein the handle comprises an upper handle having the grip handle at an upper end thereof and a lower handle connected with the wheel at a lower end thereof; wherein a lower end of the upper handle is pivotally connected with an upper end of the lower handle;
wherein the link rod includes an upper link rod inside the upper handle and a lower link rod inside the lower handle; wherein an upper end of the upper link rod is connected with the counter, and a lower end of the upper link rod includes an upper link joint; wherein a lower end of the lower link rod is connected with the wheel and the upper end of the lower link rod includes a lower link joint engaged with the upper link joint; wherein when the upper handle and the lower handle rotate relatively to each other to a side-by-side state, the upper link joint disengages from the lower link joint; wherein when the upper handle and the lower handle rotate relatively to each other to a straight-line state, the upper link joint engages with the lower link joint.

5. The measuring wheel as claimed in claim 2, wherein a joint, where the upper handle connects with the lower handle, comprises a fastening piece to hold the upper and lower handles together; wherein the fastening piece comprises an upper fastener at the lower end of the upper handle, and a lower fastener at the upper end of the lower handle; wherein the upper fastener is able to engage with or disengage from the lower fastener.
